(19) United States
(12) Patent Application Publication
(10) Pub. No.: US 2004/0107126 A1
(43) Pub. Date: Jun. 3, 2004

(54) Engineer assignment method

(75) Inventors: Kenji Kataoka, Yokohama (JP); Toshiichirou Sasaki, Iwaki (JP); Tomoichi Ebata, Sagamihara (JP); Minoru Koizumi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/678,017

(22) Filed: Oct. 1, 2003

(30) Foreign Application Priority Data
Oct. 4, 2002 (JP) 2002-291785

(51) Int. Cl. G06F 17/60

(52) U.S. Cl. 705/8

(57) ABSTRACT

A key of a building and a tool may be required for responding to various incidents that occur in targets to be processed. The maintenance engineer closest to the target mat not carry the key and tool. Optimum selection of the maintenance engineer cannot be achieved with current locations of the maintenance engineer candidates and of the target. Location information on a key and tool required for processing an incident that occurs in a target to be processed is managed. Additionally, when at least one maintenance engineer who processes the incident is selected, in accordance with a predetermined rule that location information on the maintenance engineer candidates, on the target, and on the key and tool required for the process request should be considered to select at least one maintenance engineer who processes the incident, the maintenance engineer is selected.

### CROSS-REFERENCES TO RELATED APPLICATIONS

This application claims priority based on a Japanese patent application, No. 2002-291785 filed on Oct. 4, 2002, the entire contents of which are incorporated herein by reference.

### BACKGROUND OF THE INVENTION

The present invention relates to a method for assigning engineers who respond to various incidents occurring in, e.g., facilities and apparatuses distributed in a wide field.

For example, Japanese Laid Open Patent Publication No. 11-335020 discloses a conventional engineer assignment method in a system for remotely monitoring, e.g., facilities and apparatuses distributed over a wide field to achieve security, process, and check service. In this method, in accordance with current locations of maintenance teams and location information on a building which transmitted a maintenance request signal, the maintenance team is selected. Alternatively, in accordance with the current locations of maintenance teams, the location information on the building, and traffic information, the maintenance team is selected. Additionally, abnormalities to which the maintenance teams can respond are previously registered so that the maintenance team which certainly responds to an abnormality is selected in consideration of contents of the abnormalities.

A key of an immovable object such as a building, a tool, and the like may be required to respond to various incidents such as a maintenance request and occurrence of an abnormality. However, these required key and tool may not be provided around an engineer closest to a target to be processed. An optimum engineer cannot be selected using only current locations of the engineers and location information of the target to be processed. Other information needs to be considered to select the optimum engineer.

### BRIEF SUMMARY OF THE INVENTION

The present invention provides a method wherein location information on bodies such as keys and tools are managed to process an incident that occurs in a target to be processed, and a rule considering location information on engineer candidates, on the target to be processed, and on the bodies required to respond to a process request is predetermined to select an engineer in accordance with the rule.

According to one aspect of the invention, the target to be processed is, for example, an immovable object such as a building and a movable object such as an automobile, and processing of the incident means a report about abnormality occurrence or a response to a maintenance request (check, investigation, or repair), which report and request are transmitted from the target to be processed.

The present invention achieves selection of a more optimum engineer for quickly and optimally responding to a process request.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 exemplifies a diagram of a process backup system according to an embodiment;

FIG. 2 exemplifies a block diagram of a terminal according to an embodiment;

FIG. 3 exemplifies a block diagram of a center device according to an embodiment;

FIG. 4 exemplifies a block diagram of a mobile terminal according to an embodiment;

FIG. 5 exemplifies a block diagram of terminal's hardware according to an embodiment;

FIG. 6 exemplifies an alarm format according to an embodiment;

FIG. 7 exemplifies a block diagram of immovable object management information according to an embodiment;

FIG. 8 exemplifies a block diagram of alarm management information according to an embodiment;

FIG. 9 exemplifies a block diagram of standby station management information according to an embodiment;

FIG. 10 exemplifies a block diagram of maintenance engineer management information according to an embodiment;

FIG. 11 exemplifies a block diagram of process management information according to an embodiment;

FIG. 12 exemplifies a flowchart of a maintenance engineer assignment section according to an embodiment;

FIG. 13 exemplifies a flowchart of a process management section according to an embodiment;

FIG. 14 exemplifies a format of a process request message according to an embodiment;

FIG. 15 exemplifies a format of a process status report message according to an embodiment; and

FIG. 16 exemplifies an example of a screen display of a mobile terminal according to an embodiment.

### DETAILED DESCRIPTION OF THE INVENTION

An embodiment when a target to be processed which is an immovable object such as a building is maintained by applying the present invention to a remote monitor system, is explained below.

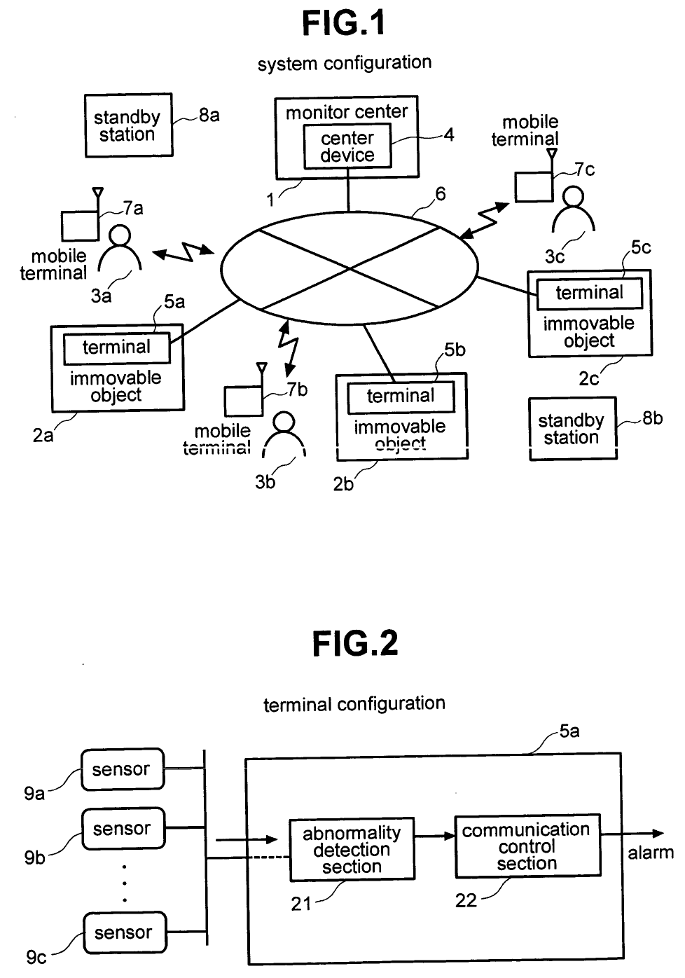

FIG. 1 shows a configuration of the remote monitor system. The targets to be processed, immovable objects 2a, 2b, and 2c, are respectively equipped with terminals 5a, 5b, and 5c for managing a plurality of facilities. A monitor center 1 is equipped with a center device 4 for remotely monitoring operation statuses of the terminals 5a, 5b, and 5c. The center device 4 and terminals 5a, 5b, and 5c are, always or when necessary, connected to each other via a communication line 6. Engineers (hereinafter called maintenance engineers) 3a, 3b, and 3c carry mobile terminals 7a, 7b, and 7c, respectively. Data transmission/reception can be done between the center device 4 and terminals 5a, 5b, and 5c. Standby stations 8a and 8b are used for standby of the maintenance engineers 3a, 3b, and 3c and for storing keys of the immovable objects 2a, 2b, and 2c and tools required for processing. The number of immovable objects and their terminals, maintenance engineers, and mobile terminals is optional. In the example of FIG. 1, the number of each component is three.

As shown in FIG. 2, the terminals 5a, 5b, and 5c each have an abnormality detection section 21 and a communication control section 22. The abnormality detection section can receive data from sensors 9a, 9b, and 9c, and detect contents of abnormalities detected by the sensors 9a, 9b, and 9c. The communication control section 22 processes alarm transmission for reporting the detected abnormalities to the center device 4.

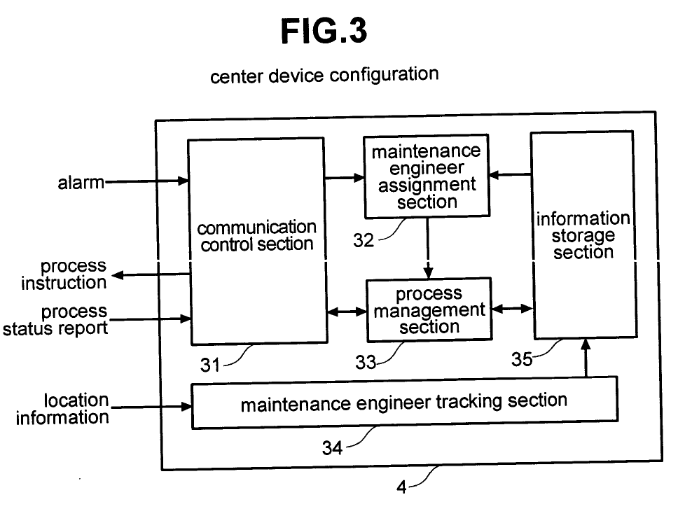

As shown in FIG. 3, the center device 4 has a communication control section 31, an engineer assignment section 32 (in this embodiment, maintenance engineer assignment section 32), process management section 33, and a maintenance engineer tracking section 34. An information storage section 35 stores information required for remote monitoring and processing. The maintenance engineer tracking section 34 receives location information transmitted from the mobile terminals 7a, 7b, and 7c carried by the maintenance engineers 3a, 3b, and 3c to recognize current locations of the maintenance engineers 3a, 3b, and 3c. The communication control section 31 receives alarms transmitted from the terminals 5a, 5b, and 5c, and transmits/receives data to/from the mobile terminals 7a, 7b, and 7c carried by the maintenance engineers 3a, 3b, and 3c. The maintenance engineer assignment section 32 stores a predetermined rule, and selects, in accordance with the rule, a maintenance engineer most suitable for a process from the maintenance engineers 3a, 3b, and 3c in response to a received alarm. The process management section 33 transmits process instructions to the maintenance engineer selected from the maintenance engineers 3a, 3b, and 3c, and manages process statuses in accordance with process status reports transmitted from the maintenance engineers 3a, 3b, and 3c.

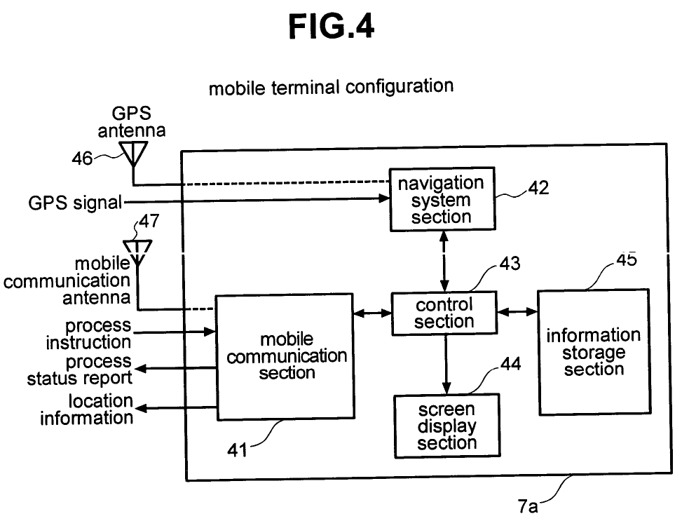

As shown in FIG. 4, each of the mobile terminals 7a, 7b, and 7c carried by the maintenance engineers 3a, 3b, and 3c has a mobile communication section 41, a navigation system section 42, a control section 43, a screen display section 44, and an information storage section 45, and is equipped with a GPS antenna 46 and a mobile communication antenna 47. The mobile communication section 41 transmits/receives data to/from the center device 4. The navigation system section 42 measures locations of the mobile terminals 7a, 7b, and 7c in accordance with GPS signals received by the GPS antenna 46. The control section 43 produces a screen in accordance with map information and current location information output from the navigation system section 42 and with process instructions transmitted from the center device 4, and outputs the screen to a screen display section 44. Additionally, the control section 43 periodically transmits the location information to the center device 4, and transmits process status reports to the center device 4 in response to operations of the maintenance engineers 3a, 3b, and 3c.

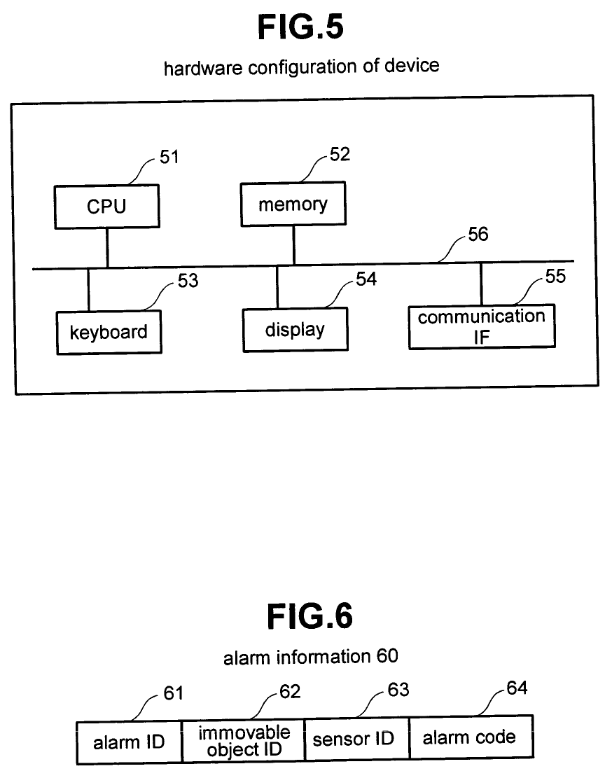

FIG. 5 shows a hardware configuration of the terminals 5a, 5b, and 5c, the center device 4, and the mobile terminals 7a, 7b, and 7c. Like a general data processing device, each has a hardware configuration including a CPU 51, memory 52, a keyboard 53, a display 54, a communication interface 55, and a communication line 56 such as a bus connecting these components. The CPU 51 executes a program stored in the hardware or the memory 52, or the program execution and the hardware are combined, so that each process section of the devices is achieved. Various types of information required for the program and its execution may be previously stored in the memory 52, or introduced, when necessary, from other devices via a detachable storage or communication medium.

Operation of a First Embodiment is Explained.

The operation while abnormalities are detected in immovable objects 2a, 2b, and 2c, and reported to a monitor center 1, is explained. The abnormality detection section 21 in the terminals 5a, 5b, and 5c always monitors abnormality detection by the sensors 9a, 9b, and 9c, and produces alarm information 60 shown in FIG. 6 when the sensors 9a, 9b, and 9c detects abnormalities. Then, the abnormality detection section 21 transmits the alarm to the center device 4 via a communication control section 22. A format of the alarm information 60 includes alarm IDs (field 61), immovable object IDs (field 62) for identifying the immovable objects 2a, 2b, and 2c, sensor IDs (field 63) for identifying a sensor that detects an abnormality, and alarm codes (field 64) for identifying contents of alarms. Numbers which are managed in the terminals 5a, 5b, and 5c and uniquely determined are set to the alarm IDs.

As described above, when the sensors 9a, 9b, and 9c detect abnormalities, the terminals 5a, 5b, and Sc transmit the alarm information 60 to the center device 4 to request the process.

Next, operation of the center device 4 are explained. First, immovable object management information, alarm management information, standby station management information, maintenance engineer management information, and process management information stored in an information storage section 35 are explained.

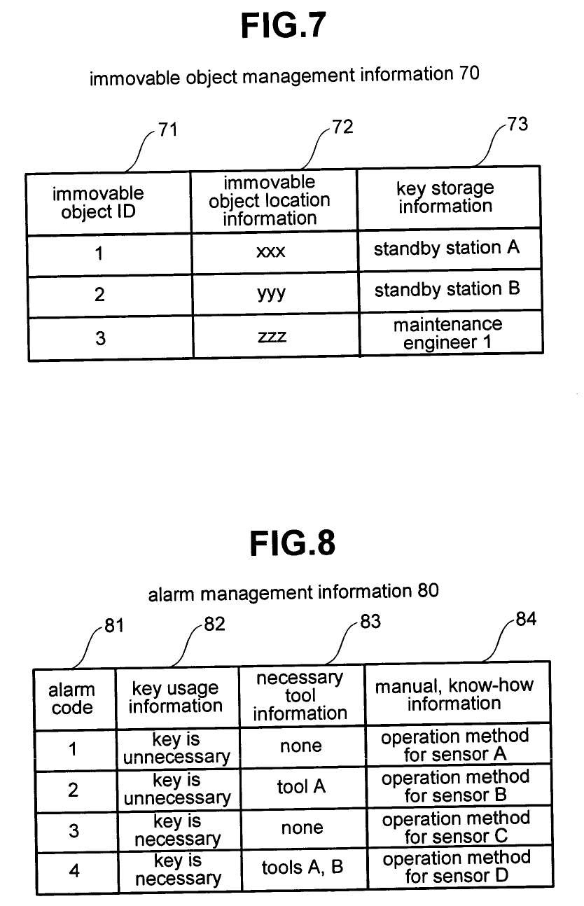

Immovable object management information 70 has a configuration shown in FIG. 7. Immovable object IDs (field 71) respectively provided to the immovable objects 2a, 2b, and 2c, location information (field 72) of the immovable objects 2a, 2b, and 2c, and key storage information (field 73) of the immovable objects 2a, 2b, and 2c are set in the immovable object management information 70. In this embodiment, each of the immovable objects 2a, 2b, and 2c has only one key, which is stored in a standby station 8a or 8b, or carried by any one of the maintenance engineers 3a, 3b, and 3c. In the key storage information (field 73), when the key is stored in the standby station 8a or 8b, a name of the standby station 8a or 8b is set, and when any one of the maintenance engineers 3a, 3b, and 3c has the key, the maintenance engineer ID is set.

Alarm management information 80 has a configuration shown in FIG. 8. In the alarm management information 80, key usage information (field 82) for judging whether keys of the immovable objects 2a, 2b, and 2c are required for the process, necessary tool information (field 83) on tools required for the process, and manuals and know-how information (field 84) required for the process are set.

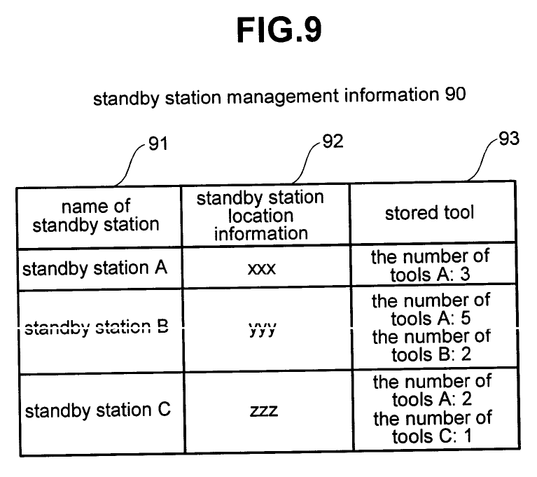

Standby station management information 90 has a configuration shown in FIG. 9. In the standby station management information 90, names of the standby stations 8a and 8b (field 91), location information (field 92), and tool information (field 93) on tools stored in the standby stations are set.

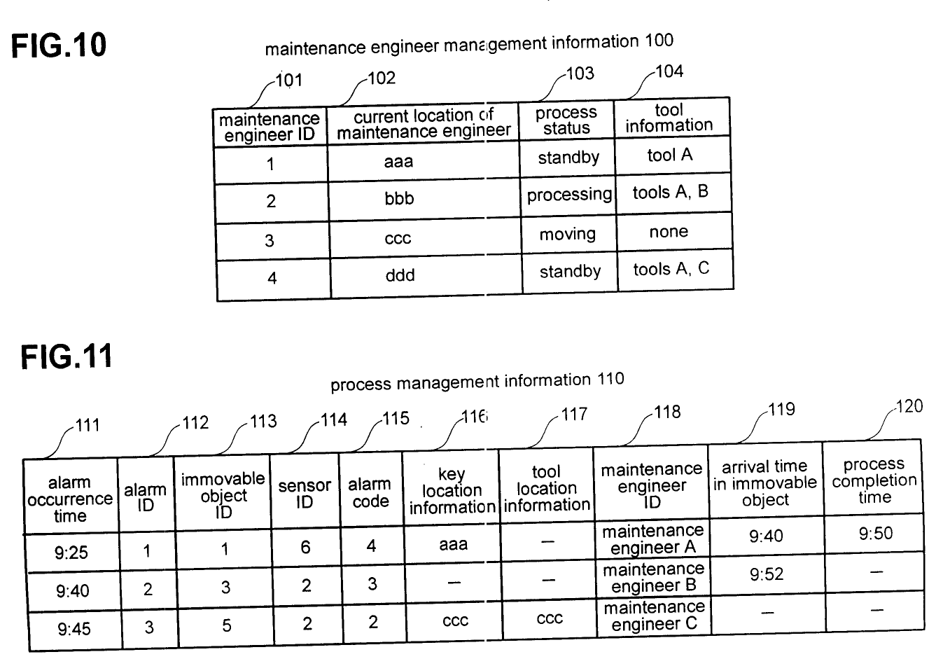

Maintenance engineer management information 100 has a configuration shown in FIG. 10. In the maintenance engineer management information 100, IDs (field 101) for identifying the maintenance engineers 3a, 3b, and 3c, current locations (field 102) of the maintenance engineers 3a, 3b, and 3c, process statuses (field 103) of the maintenance engineers 3a, 3b, and 3c, and tool information (field 104) on tools carried by the maintenance engineers 3a, 3b, and 3c are set. Current locations 92 of the maintenance engineers 3a, 3b, and 3c are updated by a maintenance engineer tracking section 34. In the process status field, three statuses “standby”, “moving to a target to be processed”, and “processing in an immovable object” are managed, and updated by the after-mentioned process management section 33.

Process management information 110, having a configuration shown in FIG. 11, manages the statuses and history of processes. In the process management information 110, alarm occurrence times (field 111), alarm IDs (field 112), immovable object IDs (field 113), sensor IDs (field 114), alarm codes (field 115), key location information (field 116), tool location information (field 117), maintenance engineer IDs (field 118), arrival times in immovable objects (field 119), and process completion times (field 120) are set.

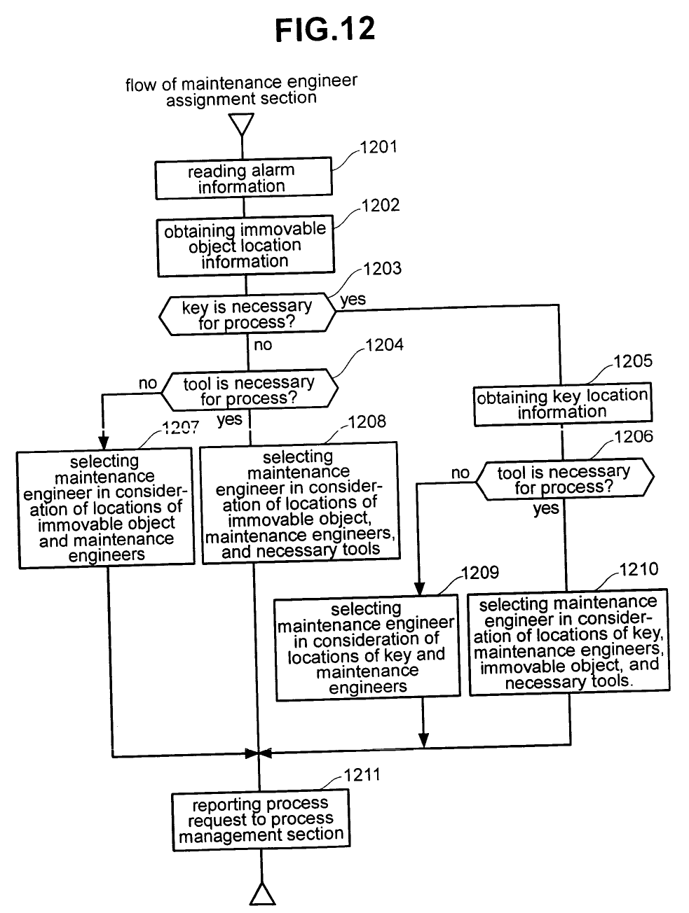

Next, operation of the center device 4, which has received alarm information 60, is explained. The alarm information 60 transmitted from any one of the terminals 5a, 5b, and 5c is reported to a maintenance engineer assignment section 32 via a communication control section 31. The maintenance engineer assignment section 32 executes a flow shown in FIG. 12.

First, an alarm ID, an immovable object ID, a sensor ID, and an alarm code which are set in the received alarm information 60 are read (step 1201). In accordance with the immovable object ID, the maintenance engineer assignment section 32 obtains location information on the corresponding one of the immovable objects 2a, 2b, and 2c from immovable object management information 70 (step 1202).

Next, in accordance with the alarm codes 64, alarm management information 80 is referenced to identify whether a key of the immovable object is necessary to process the immovable object (step 1203), and whether there is a tool necessary for the process (steps 1204, 1206). When the key is necessary, the immovable object management information 70 is referenced in accordance with the immovable object IDs to obtain storage information on the key. Then, location information on the key is obtained from the key storage information (step 1205). The key location information can be obtained from the standby station information 90 in accordance with names of the standby stations when the key is stored in a standby station 8a or 8b, and from the maintenance engineer management information 100 in accordance with the maintenance engineer IDs when any one of the maintenance engineer 3a, 3b, or 3c carries the key.

Assignment of the maintenance engineers 3a, 3b, and 3c is explained below. First, the maintenance engineer assignment method is explained for the situation when the alarm does not require a key or a tool. In this case, in consideration of location information on the immovable object 2 where the alarm occurs and on the maintenance engineer 3, the maintenance engineer 3 who responds to the process is determined (step 1207). In other words, location information on all the standby maintenance engineer candidates 3a, 3b, and 3c is obtained from the maintenance engineer management information 100, and compared to the location information on the immovable object 2, which location information is obtained in step 1202, to select the maintenance engineer 3 closest to the immovable object 2. The maintenance engineer assignment section 32 calculates the moving time by comparing location information and map information.

Next, the maintenance engineer assignment method is explained for the situation when the alarm requires a tool but no key. In this case, in consideration of the location information on the immovable object 2 where the alarm occurs, on the maintenance engineer 3 who is a standby candidate, and on the required tool, the maintenance engineer 3 who responds to the process is determined (step 1208). In other words, the maintenance engineer 3 who carries the required tool and is closest to the immovable object 2 is selected. Concretely, in reference to the maintenance engineer management information 100, location information on the maintenance engineers 3a, 3b, and 3c who are on standby and information on the carried tools are obtained.

When the maintenance engineer 3 carries the required tool, a time that the maintenance engineer 3 moves from the current location to the location of the immovable object 2, which location is obtained in step 1202, is calculated.

When not carrying the required tool, the maintenance engineer 3 visits a standby station to carry the required tool. After that, elapsed times until the arrival in the immovable objects 2a, 2b, and 2c are calculated. In other words, in reference to the standby station management information 90, location information on a standby station where the required tool is stored is obtained, and a moving time that the maintenance engineer 3 moves from the current location to the standby station and a moving time that the maintenance engineer 3 moves from the standby station to the immovable object 2 are summed up to calculate the elapsed time until the arrival.

In accordance with the above-described procedure, the elapsed times until all the standby maintenance engineers 3 carrying the required tools arrive in the immovable object 2 are calculated to select the maintenance engineer 3 who is the earliest to arrive in the immovable object 2.

Next, the maintenance engineer assignment method is explained for when the alarm requires a key. First, the maintenance engineer assignment method when the alarm requires a key and no tool is explained. In this case, the maintenance engineer 3 who is the earliest to arrive in a location of the key is the earliest to arrive in the immovable object 2 with the key.

Thus, location information on the key and on the maintenance engineers 3 who are candidates is considered to select the maintenance engineer 3 who responds to the alarm (1209).

When the key is stored in a standby station, location information on all the standby maintenance engineers 3 is obtained from the maintenance engineer management information 100, and compared to the key location information obtained in step 1205 to select the maintenance engineer 3 who is the earliest to arrive in the standby station the key is stored.

When any one of the maintenance engineers 3 carries the key, the maintenance engineer 3 who carries the key is selected. When the maintenance engineer 3a, 3b, or 3c who carries the key is not on standby, a process for the present alarm is executed after the current process is completed.

Finally, the engineer assignment when an alarm requires a key and tool is explained. In this case, in accordance with location information on the key, on the maintenance engineers 3, on the required tool, and on the immovable object 2, the maintenance engineer 3 who responds to the process is determined (step 1210). In other words, the maintenance engineer 3 who carries the key and tool and is the earliest to arrive immovable object 2 is selected.

When the key is stored in a standby station, current location on the standby maintenance engineers 3 and information on the carried tools are obtained from the maintenance engineer management information 100, and location information on the standby station where the required tool is stored is obtained from the standby station management information 90. In accordance with the obtained information and the location information on the immovable object 2 and the key, which location information is obtained in steps 1202 and 1205, the maintenance engineer 3 is selected.

Calculation of the elapsed time until the standby maintenance engineer 3, who initially does not carry the required tool, carries the required tool and arrives in the immovable object 2 is concretely explained. The key is stored in a standby station, so that the maintenance engineer 3 needs to visit the standby station where the key is stored. When the required tool is not stored in the standby station, the maintenance engineer 3 needs to visit another standby station where the tool is stored. The maintenance engineer 3 needs to visit the standby station where the key is stored and the standby station where the tool is stored before visiting the immovable object 2. The elapsed times that the maintenance engineer 3 moves from the current location to the first standby station, from the first standby station to the second station, and from the second station to the immovable object 2 are calculated and summed up.

Whether the maintenance engineers 3 who are standby candidates carry the required tool and where the maintenance engineers 3 visit to carry out the required tool are identified. Then, an elapsed time that the maintenance engineers 3 carry out the key and required tool and visit the immovable object 3 is calculated. When the maintenance engineer 3 carries the key, the maintenance engineer 3a, 3b, or 3c is selected as one who responds to the process.

There is the possibility that the maintenance engineer 3 who carries the key is not on standby. Additionally, there is the possibility that the maintenance engineer 3 does not carry the required tool. In this case, after the current process, a process for the alarm is executed. In this case, the maintenance engineer 3 visits the standby station where the key is stored, carry out the key, and visit the immovable object 2.

Through the above-described procedure, the maintenance engineer 3 who is the earliest to carry the key of the immovable object 2 and the required tool can be selected. The assignment method is one example. The maintenance engineer assignment section 32 assigns the maintenance engineers in accordance with another rule.

After the maintenance engineer 3 is selected in each step 1207, 1208, 1209, and 1210, a process request including the alarm information 60, the location information on the key and tool, and the ID of the selected maintenance engineer is reported to the process management section 33 (step 1211). When a key and tool are required for the process, and when the maintenance engineer needs to visit a standby station to carry the key and tool, location information on the standby station may be reported.

A procedure from the selection of the maintenance engineer 3 who responds to the process to the completion of the process executed between the center device 4 and mobile terminal 7 is explained.

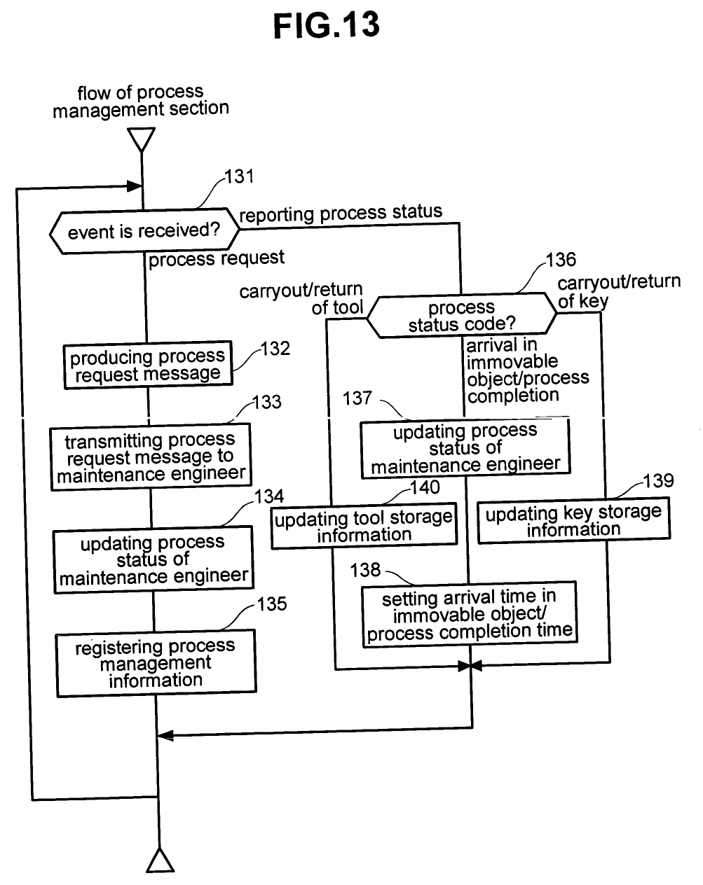

The process management section 33 executes a flow shown in FIG. 13. The process management section 33 instructs the maintenance engineers 3a, 3b, and 3c to execute a process when a process request occurs, and manages a process status reported by the maintenance engineers 3a, 3b, and 3c.

First, when a process request occurs from an event wait state (step 131), a process request message 1400 is generated in accordance with information transmitted from the maintenance engineer assignment section 32 (step 132), and the mobile terminal 7 of the selected maintenance engineer 3 receives the process request message 1400 (step 133).

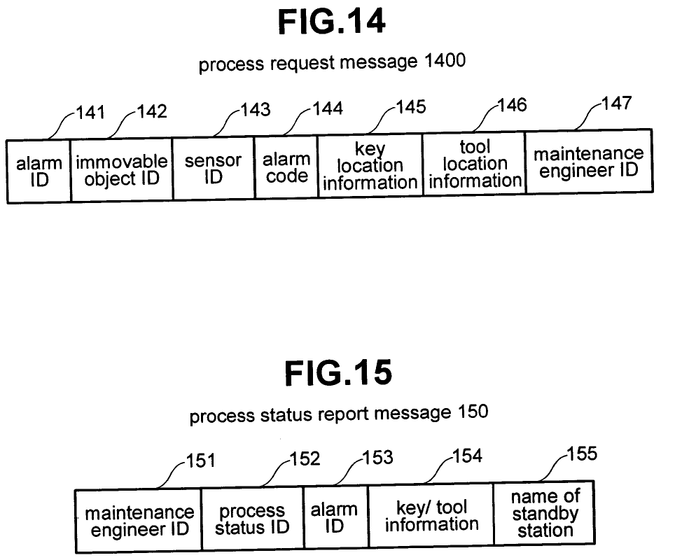

FIG. 14 shows a configuration of the process request message 1400. The process request message 1400 includes fields 141 to 147 where an alarm ID, immovable ID, sensor ID, alarm code, key location information, tool location information, and ID of the assigned maintenance engineers 3a, 3b, or 3c are set, respectively.

After the process request message 1400 is transmitted (step 133), a process status of the maintenance engineer management information 100 of the selected maintenance engineer 3 is updated from “standby” to “moving to the immovable object 2” (step 134). When the selected maintenance engineer 3 is processing another alarm, the process status is not updated.

After the process management information 110 is registered (step 135), the event wait state starts again. In this registration, in addition to the alarm occurrence times, the alarm IDs, immovable IDs, sensor IDs, alarm codes, key location information, tool location information, and IDs of the assigned maintenance engineers 3a, 3b, and 3c, which are set in the process request message 140, are respectively set in fields 112 to 118 of the process management information 110.

Next, a procedure for reception of a process status report message 150 from the mobile terminals 7a, 7b, or 7c in the event wait state (step 131) is explained.

As shown in FIG. 15, the process status report message 150 includes fields 151 to 155 where a processing maintenance engineer ID, process status code, alarm ID, key/tool information, and name of a standby station are set, respectively.

There are six statuses as the process status codes, “carryout of key”, “return of key”, “carryout of tool”, “return of tool”, “arrival in immovable object to be processed”, “process completion”. These codes are transmitted from the maintenance engineer 3 when the maintenance engineer 3 carries out and returns the key, carries out and returns the tool, arrives in the immovable object to be processed, and completes the process.

The alarm ID under the process is set when the process status code is “arrival in immovable object to be processed” and “process completion”. The key/tool information and a name of the standby station are set when the process status code is “carryout of key”, “return of key”, “carryout of tool”, and “return of tool”. In “carryout of key” and “return of key”, the immovable object ID and a name of the standby station are set to identify for which immovable object 2 the key is used and to which standby station the key is returned. In “carryout of tool” and “return of tool”, the tool information and a name of the standby station are set to identify which tool is carried out and in which standby station the tool is used.

In step 136, when the process status message 150 is received, the process is executed in accordance with the process status code.

In the case of arrival in immovable object, after the process status of the maintenance engineer management information 100 is set as “processing” (step 137), a current time is set as an arrival time in an immovable object of the process management information 110 (step 138).

In the case of process completion, after the process status of the maintenance engineer management information 100 is set as “standby” (step 137), a current time is set as an arrival time in immovable object of the process management information 110 (step 138). Even after the process completion, another alarm may have been already assigned. Therefore, the process status is set as “standby” after the process management information 110 is checked to confirm that a process has not been assigned. When another alarm has been already assigned, the process status is set as “moving to another immovable object 2”.

When the process status code is “carryout of key”, an ID of the maintenance engineer who carries out the key is set in key storage information of the immovable object management information 70 (step 139). When the process status code is “return of key”, a name of the standby station to which the key is returned is set to key storage information of the immovable object management information 70 (step 139).

When the process status code is “carryout of tool”, information on a carried-out tool is added to tool information of the maintenance engineer management information 100, and the information on a carried-out tool is deleted from tool storage information of the standby station information 90 (step 140).

In a case of “return of key”, information on the returned key is deleted from the tool information of the maintenance engineer management information 100, and from the stored tool information of the standby station management information 90 (step 140).

Through the above-described procedure, the mobile terminal 7 of the maintenance engineer 3 selected by the maintenance engineer assignment section 32 can receive a process request. Additionally, in accordance with a process status report from the mobile terminal 7, a process status of the maintenance engineer and key/tool information can be updated.

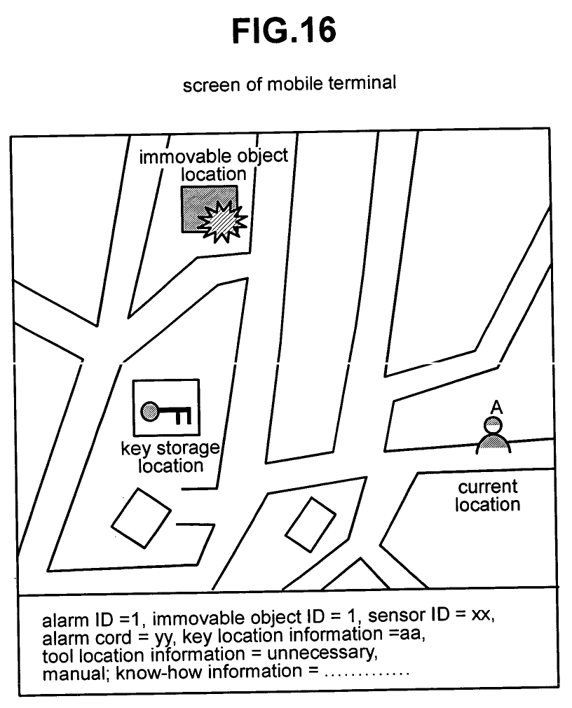

In the mobile terminal 7a, 7b, and 7c, when the communication control section 31 receives the process request message 1400, the control section 43 reads the location information on the immovable object 2 from the memory section 45, and obtains the map information and the locations of the mobile terminal 7a, 7b, and 7c outputted from the navigation system section 42. In accordance with these pieces of information, a map around the immovable object is displayed on a screen display section 44 as shown in FIG. 16, and marks representing locations of the mobile terminals 7 and immovable object 2 and of a key and tool are displayed on the map in a composite manner. Also, the content of the alarm is displayed. As a result, in accordance with the content of the display section, the maintenance engineer 3 carrying the mobile terminal 7 can visit the storage location of the key and tool and immediately respond to the process. Additionally, when carrying out or return the key, carrying out or return the tool, arriving in the immovable object to be processed, and completing the process, the maintenance engineer 3 transmits the process status message by means of the mobile terminal 7, so that the process status of the center device 4 can be updated.

In the above-described embodiment, when the process request is transmitted (step 133), the required information can be simultaneously transmitted. The concrete procedure is as follows.

Whether the maintenance engineer 3 selected by the maintenance engineer assignment section 32 is experienced in processing the alarm is confirmed. This can be judged by searching the process management information 110 in accordance with the maintenance engineer IDs and alarm codes. When a maintenance engineer 3 having no or little experience is assigned, the process request message 1400 as well as manual and know-how information required for the process are transmitted to the mobile terminal 7. The received manual and know-how information is displayed on a display section of the mobile terminal 7. As a result, a maintenance engineer 3 having no or little experience can easily execute the process.

In the above-described embodiment, the method where the maintenance engineer assignment section 32 selects the standby maintenance engineer 3 is explained. In addition to the standby maintenance engineer 3, the maintenance engineers 3a, 3b, and 3c who are processing other alarms can be selected in consideration of their prediction times of completing the processes.

The process management information 110 records arrival times in the immovable objects (field 119) and process completion times (field 120) of the past alarms, so that a time required for the process completion in the immovable object 2 can be calculated. A time that the maintenance engineer 3 who is executing the process or moving to the immovable object 2 completes a current process can be predicted using the past process times and the moving time calculated when the maintenance engineers are assigned. In consideration of the prediction time, the maintenance engineer 3 who is not on standby can be a candidate to be selected.

The maintenance engineer 3 who is executing the process may input the process completion prediction time. For example, a process status report message 150 for reporting the process completion prediction time to the center device 4 is additionally defined to cause the maintenance engineer 3 to report, by means of the mobile terminal 7, the process completion prediction time to the center device 4. As a result, more optimum maintenance engineer assignment can be achieved in consideration of also the maintenance engineer 3 who is executing the process.

In the above-described embodiment, one maintenance engineer 3 is assumed to execute the process. According to other embodiments, a plurality of the maintenance engineers 3 execute the process. For example, depending on a content of an alarm, an emergency process may be required. A longer time is required when the maintenance engineer 3 visits a standby station to carry a key and tool, compared to when the maintenance engineer 3 directly visits the immovable object 2. Therefore, regardless of a possession status of the required key and tool, the standby maintenance engineer 3 who is closest to the immovable object 2 is selected to directly visit the immovable object 2. When the maintenance engineer 3 has no key and tool, another maintenance engineer 3 is assigned to visit, after carrying the key and tool, the immovable object 2 to respond to the process.

In this case, information managing an emergency level of an alarm is added to the alarm management information 80. In the maintenance engineer assignment for the emergency alarm, the standby maintenance engineer 3 closest to the immovable object 2 is selected, and the process request message 1400 for causing the maintenance engineer 3 to directly visit the immovable object 2 is transmitted. When the maintenance engineer 3 directly visiting the immovable object 2 has no required key and tool, the standby maintenance engineer 3 who is the earliest to visit the immovable object 2 with the required key and tool is selected, and the process request message 1400 is transmitted. This achieves earlier arrival in the immovable object 2, in other words, a not perfect but quick response.

In the above-described embodiment, the method for selecting the maintenance engineer 3 on the basis of an elapsed time until the maintenance engineer 3 starts to execute the process is explained. In reference to not only the times but also the process history, the maintenance engineer 3 can be selected.

For example, in reference to the process management information 110, the maintenance engineer 3 who has little experience can be removed from the assignment candidates, and the maintenance engineer 3 who has executed the processes many times can be assigned. On the other hand, the maintenance engineer 3 who has little experience can be preferentially assigned. In consideration of the past process history, accuracy of the processes can be increased, and loads of the processes by the maintenance engineers 3a, 3b, and 3c can be evenly distributed.

In the above-described embodiment, conditions required for the processes are registered in the center device 4. When requesting a process, the terminals 5, which are targets to be processed, may report conditions required for the processes to the center device 4.

This is achieved by adding the process conditions to the alarm information 60 when the terminals 5a, 5b, and 5c transmit alarms. As a result, even when the condition for the process changes depending on the status, the optimum maintenance engineer 3 can be selected.

An embodiment for repairing an automobile, which is a target to be processed, by applying the present invention to a visiting repair service, is now explained.

Except that the target to be processed is a movable object called the automobile, the whole configuration and process contents are the same as the first embodiment. Automobiles 2a, 2b, and 2c are equipped with terminals 5a, 5b, and 5c, from which alarms are transmitted to the center device 4 when abnormalities are detected. In the first embodiment, the targets are fixed. In the second embodiment, a function for periodically transmitting location information to the center device 4 is added because the automobiles move.

GPS antennas, like the mobile terminals 7a, 7b, and 7c of the first embodiment, are equipped to obtain the location information, and the terminals 5a, 5b, and 5c periodically transmit the location information to the center device 4, so that the above-described operation is achieved. The center device 4 receives the transmitted location information, and adds the updates of the location information on the automobiles 2a, 2b, and 2c (in the first embodiment, immovable objects) to monitor the location information of the automobiles 2.

An owner of an automobile observes the repair of the automobile, and a tool is necessary for the repair. Like in step 1208 of the first embodiment, the center device 4, when receiving an alarm, selects a maintenance engineer in consideration of tool location information, automobile location information, and location information on the maintenance engineers 3a, 3b, and 3c. According to the present embodiment, the optimum maintenance engineer for the repair of the automobile can be selected.

As described above, the present invention is not limited to the above-described embodiments, but applicable to selection of maintenance engineers who respond to incidents occurring in various targets to be processed.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. An engineer assignment method for selecting an engineer who processes an incident occurring in a target to be processed, comprising:
transmitting a process request to a management device from the target to be processed;
managing information referenced by a predetermined rule used for selecting an engineer using the management device; and
selecting, in response to the process request, the engineer in accordance with the predetermined rule,
wherein the predetermined rule refers to location information on engineer candidates, on the target to be processed that transmits the process request, and on an object required for the process request.

2. The method of claim 1, wherein the predetermined rule refers further to information on tools carried by the engineer candidates, and on a tool required to process the incident.

3. The method of claim 1, wherein information on a tool required to process the incident is contained in the process request.

4. The method of claim 1, further comprising repeatedly obtaining location information on the target to be processed or location information on the object when the target to be processed or the object move using the management device.

5. The method of claim 1, wherein the predetermined rule refers to a process status representing whether the engineer candidates are on standby.

6. The method of claim 1, wherein the predetermined rule refers also to a prediction time of process completion by an engineer who is processing another incident.

7. The method of claim 1 wherein:
the predetermined rule refers to location information on engineer candidates and location information on a target to be processed to cause the management device to select at least one engineer.

8. The method of claim 1 wherein:
the predetermined rule refers to location information on the selected engineer and location information on the object to cause the management device to select further at least one engineer.

9. The method of claim 1, wherein the management device manages process history of engineer candidates, and wherein the method further comprising:
referring to the process histories of the engineer candidates to judge whether information used for the selected engineer to process the incident is necessary, and
transmitting the information used to process the incident to the selected engineer when the information is necessary.
